(19) United States
(12) Patent Application Publication
(10) Pub. No.: US 2025/0243907 A1
(43) Pub. Date: Jul. 31, 2025

(54) SEAL WITH HELICAL AIR VENTS

(71) Applicant: AKTIEBOLAGET SKF, GOTEBORG (SE)

(72) Inventors: Robert D. Pecak, Naperville, IL (US); John Arthur Wilkins, Chicago, IL (US)

(21) Appl. No.: 18/422,241

(22) Filed: Jan. 25, 2024

(51) Int. Cl. F16C 33/72

(52) U.S. Cl. CPC F16C 33/723; F16C 33/726; F16C 2326/02

(57) ABSTRACT

A wheel end assembly includes a seal for sealing the annular space between an inner member and an outer member, one of which is a static component and the other a rotatable component. The seal includes an annular case having a cylindrical portion with a circumferential surface engaged with the static component and a flange portion extending radially from the cylindrical portion. An annular seal member is attached to the flange portion and has a sealing lip(s) engaged with the rotatable component so as to separate the annular space into a first chamber and a second chamber. At least one air vent includes a channel extending circumferentially and axially around at least a section of the circumferential surface of the case cylindrical portion, the channel having an inlet fluidly connected with the first chamber and an outlet spaced axially from the inlet and fluidly connected with the second chamber.

### BACKGROUND OF THE INVENTION

The present invention relates to seals, and more particularly to seals for vehicle wheel end assemblies.

Wheel end assemblies are well known and typically include an inner component, such as a shaft or axle, and an outer component, typically a hub or housing, one component being connected to a wheel and rotatable relative to the other, non-rotatable or “static” component. The inner shaft/axle and the outer hub/housing are rotatably coupled by one or more bearings. In order to retain lubricant within the bearing(s) and prevent entry of contaminants, a seal is mounted adjacent to at least one and typically both axial ends of the bearing. Such seals generally include a case coupled with either the inner or outer component and a seal member attached to the case and sealingly engaged with the other component.

### SUMMARY OF THE INVENTION

In one aspect, the present invention is a vehicle wheel end assembly comprising an inner member having a central horizontal axis and an outer member disposed circumferentially about the inner member so as to define an annular space between the inner member and the outer member. One of the inner member and the outer member is a rotatable component configured to rotate about the central axis and the other one of the inner member and the outer member is a static component. A seal is provided for sealing the annular space and includes an annular case having a cylindrical portion with a circumferential surface engaged with the static component and a flange portion extending radially from the cylindrical portion. An annular seal member is attached to the flange portion of the case and has at least one sealing lip sealingly engaged with the rotatable component so as to separate the annular space into a first chamber and a second chamber. Further, at least one air vent includes a channel extending circumferentially and axially around at least a section of the circumferential surface of the cylindrical portion of the case. The channel has an inlet fluidly connected with the first chamber and an outlet spaced axially from the inlet and fluidly connected with the second chamber.

In a presently preferred application, the outer member is rotatable and the inner member is static or fixed with respect to the central axis. As such, the cylindrical portion of the case is engaged with the inner member and the flange portion of the case extends radially outwardly from the cylindrical portion. The sealing lip(s) of the seal member is/are engaged with the outer member, and preferably includes a radial sealing lip sealingly engaged with an inner circumferential surface of the outer member.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of a wheel end assembly in accordance with the present invention, shown with a seal formed in an outwardly-sealing configuration;

FIG. 2 is an enlarged, axial cross-sectional view of an upper portion of FIG. 1;

FIG. 3 is a perspective view of the seal, shown separate from the wheel end assembly;

FIG. 4 is an axial cross-sectional view of the seal;

FIG. 5 is an enlarged view of an upper portion of FIG. 4; and

FIG. 6 is an axial cross-sectional view of a wheel end assembly in accordance with the present invention, shown with a seal formed in an inwardly-sealing configuration.

### DETAILED DESCRIPTION OF THE INVENTION

Certain terminology is used in the following description for convenience only and is not limiting. The words “lower” and “upper” designate directions in the drawings to which reference is made and the words “inner”, “inwardly” and “outer”, “outwardly” refer to directions toward and away from, respectively, a designated centerline or a geometric center of an element being described. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

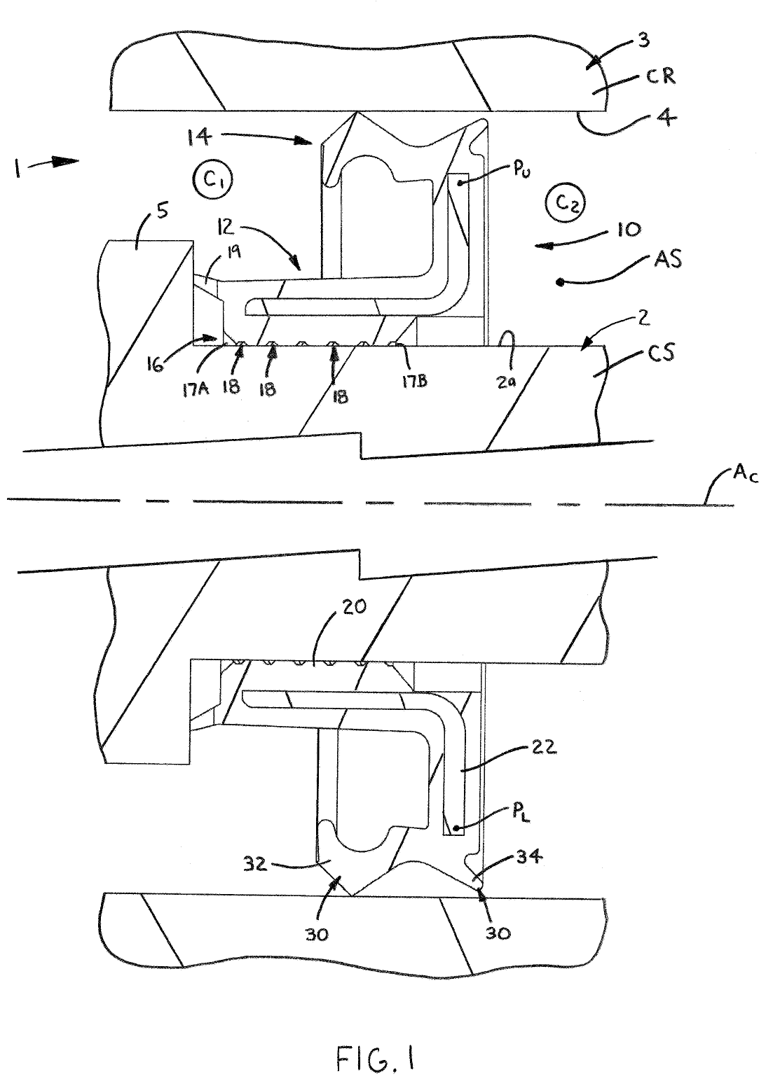

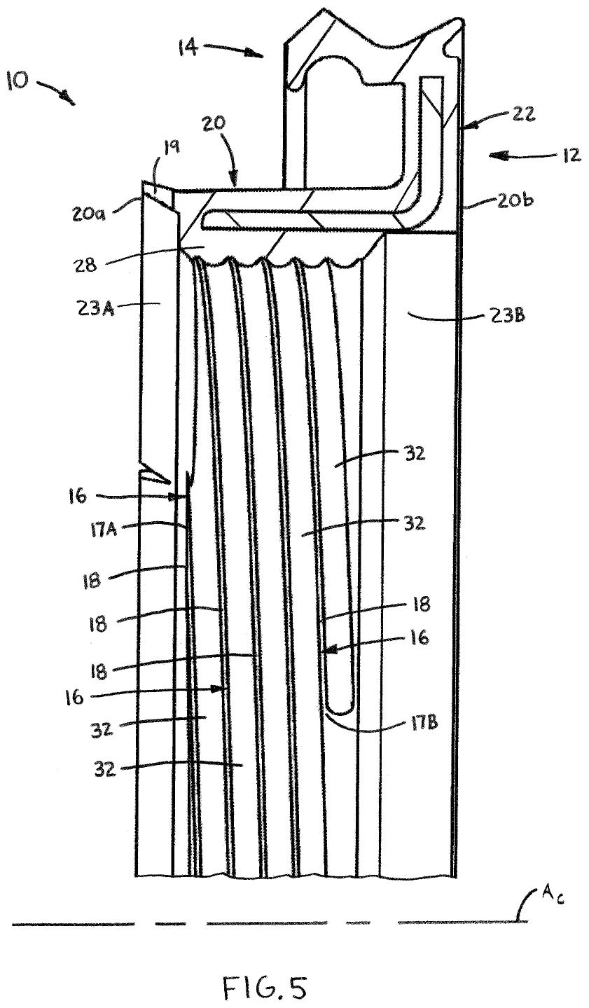

Referring now to the drawings in detail, wherein like numbers are used to indicate like elements throughout, there is shown in FIGS. 1-6 a seal 10 for a wheel end assembly 1 comprising an inner member 2, such as a shaft or an axle, and an outer member 3, for example a hub, a housing, etc. The inner member 2 has a central axis A_{C} and the outer member 3 is disposed circumferentially about the inner member 2 so as to define an annular space AS between the inner member 2 and the outer member 3; specifically, the outer member 3 has a bore 4 (FIG. 1) and the inner member 2 is disposed centrally within the bore 4. One of the inner member 2 and the outer member 3 is a rotatable component CR configured to rotate about the central axis A_{C} and the other one of the inner member 2 and the outer member 3 is a static component CS that is fixed with respect to the central axis A_{C}, as indicated in FIGS. 1, 2 and 6.

The seal 10 is provided for sealing the annular space AS, is preferably located at least at an outboard end of the wheel end assembly 1 and basically includes an annular case 12 with a cylindrical portion 20 engaged with the static component CS and an annular seal member 14 attached to the case 12. The seal member 14 is sealingly engaged with the rotatable component CR so as to separate the annular space AS into a first, “oil” chamber C₁ containing lubricant and a second, “air” chamber C₂ open to the exterior environment, i.e., is fluidly connected with the exterior of the wheel end assembly 1. As discussed in detail below, the case 12 has at least one air vent 16 including a channel 18 extending through the cylindrical portion 20 of the case 12, preferably circumferentially and axially around a circumferential surface of the case cylindrical portion 20. As such, the at least one air vent 16 fluidly connects the first and second chambers C₁, C₂, to thereby reduce air pressure within the first chamber C₁, while the seal 10 is configured to prevent lubricant flow between the chambers C₁, C₂. Further, the seal 10 may also include an annular sleeve (not shown) mounted about or within the rotatable component CR, such that the seal member 14 directly engages with the sleeve.

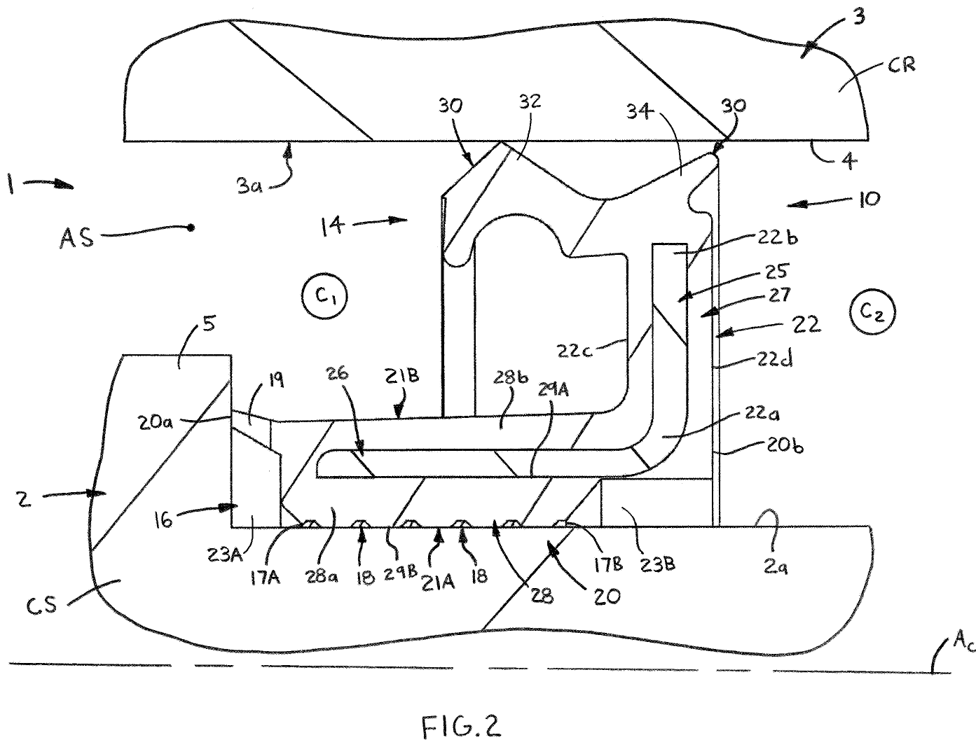

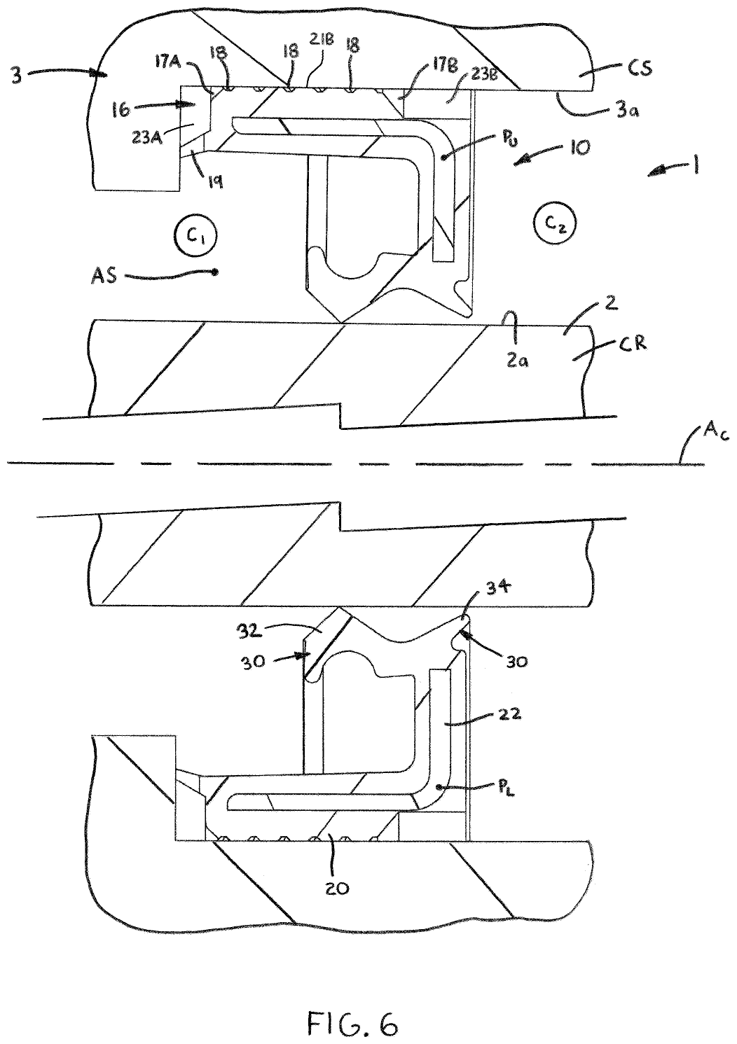

The annular case 12 includes a cylindrical portion 20 and an annular flange portion 22 extending radially from the cylindrical portion 20. More specifically, the cylindrical portion 20 has inner and outer circumferential surfaces 21A, 21B and opposing first and second axial ends 20a, 20b. When the inner member 2 functions as the static member CS, the inner circumferential surface 21A of the cylindrical portion 20 is frictionally engaged with an outer circumferential surface 2a of the inner member 2, as shown in FIGS. 1 and 2. Alternatively, when the outer member 3 functions as the static component CS, the outer circumferential surface 21B is frictionally engaged with an inner circumferential surface 3a of the outer member 3 (FIG. 6). In either case, the cylindrical portion 20 of the case 12 preferably includes an annular metallic section 26 and an annular elastomeric section 28, the elastomeric section 28 being at least disposed within the metallic section 26 when the cylindrical portion 20 is engaged with a static inner member 2, as shown in FIGS. 1 and 2, and/or alternatively disposed at least about the metallic section 26 when the cylindrical portion 20 is engaged with a static outer member 3, as depicted in FIG. 6.

Specifically, the elastomeric section 28 preferably includes a primary, sealing layer 28a and a secondary layer 28b, with the metallic section 26 being disposed within or “encased by” the two layers 28a, 28b of the elastomeric section 28, as indicated in FIG. 2. However, the elastomeric section 28 may include only the primary sealing layer 28a disposed on one circumferential surface of the metallic section 26, such that an opposing circumferential surface of the metallic section 26 is exposed or “bare” metal (structure not shown). With either structure, the primary sealing layer 28a has a first circumferential surface 29A attached to the metallic section 26 and a second circumferential surface 29B frictionally engaged with the static component CS. Preferably, the channel 18 of the at least one air vent 16 extends radially into the elastomeric section 28 of the case cylindrical portion 20, specifically inwardly from the second circumferential surface 29B, as described in further detail below, but may instead be formed in the metallic section 26, as also discussed below.

Further, the flange portion 22 has a first radial end 22a integrally formed with the second axial end 20b of the cylindrical portion 20, a second, free radial end 22b, and opposing first and second axial ends 22c, 22d, respectively. The first axial end 22c partially bounds the first chamber C₁ and the second axial end 22d partially bounds the second chamber C₂. With any flange structure, when the annular case 12 is engaged with the static component CS, the flange portion 22 extends or is oriented vertically with respect to the horizontal central axis CS, such that the flange portion 22 has a vertically uppermost point P_{U} and a vertically lowermost point P_{L}, as indicated in FIGS. 1 and 6.

Preferably, the flange portion 22 is formed substantially “straight”, i.e., extends entirely radially without any bends, etc., but may alternatively formed so as to extend at an angle, with two or more radially extending sections offset axially from each other and connected by an axial section, or formed in any other desired manner (no alternatives shown). As indicated in FIG. 2, the flange portion 22 preferably includes an inner metallic section 25 and an outer elastomeric section 27 enclosing the metallic section 25, which is most preferably integrally formed with elastomeric section 28 of the case cylindrical portion 20 and with the seal member 14. However, the flange portion 22 may alternatively be formed solely of a metallic section, such that the cylindrical portion elastomeric section 28 and the seal member 14 are separately formed members spaced radially apart.

Referring particularly to FIG. 2, the annular seal member 14 is preferably formed of an elastomeric material, such as natural or synthetic rubber, polyurethane, etc., and is attached to the flange portion 22 of the case 12, specifically at least the second radial end 22b thereof. The seal member 14 has at least one sealing lip 30 engaged with the rotatable component CR, which preferably includes both a radial sealing lip 32 and a dust lip 34 engaged with a circumferential surface of the rotatable component CR or a circumferential surface of a component disposed about or within the rotatable component CR, such as an annular sleeve (none shown). However, the seal member 14 may include any combination of radial and axial sealing lips or may even have only one or more axial sealing lips sealingly engaged with the rotatable component CR (no alternatives shown).

Referring again to FIGS. 1-6, the channel 18 of the at least one air vent 16 has an inlet 17A fluidly connected with the first chamber C₁ and an outlet 17B spaced axially from the inlet 17A and fluidly connected with the second chamber C₂. The channel 18 preferably extends circumferentially at least one hundred eighty degrees (180°) around the central axis A_{C}, most preferably at least two hundred seventy degrees (270°) around the axis A_{C}, and is preferably formed as a helix. However, the channel 18 may alternatively formed with only a slight curve between the inlet 17A and the outlet 17B or may even be formed so as to extend substantially axially or “straight” between the axial ends 20a, 20b of the case cylindrical portion 20. Further, in a presently preferred application as shown in FIGS. 1 and 2, the first axial end 22a of the case cylindrical portion 20, and specifically of the elastomeric section 28, abuts against a radial shoulder 5 of the static component CS. With this structure, the air vent 16 further includes an inlet port 19 extending radially through the case cylindrical portion 20 and an annular inlet channel 23A fluidly connecting the inlet port 19 with the inlet 17A, thereby connecting the inlet 17A with the first chamber C₁, whereas the outlet 17B is connected with the second chamber C₂ by an annular outlet channel 23B defined between the case cylindrical portion 20 and the static component CS.

With the helical structure of the channel 18 extending at least 180° about the axis A_{C}, the inlet 17A is preferably located vertically above the central axis A_{C} of the inner member 2, although the outlet 17B may be positioned either above or below the axis A_{C} due to being fluidly connected with the second or “air” chamber C₂. Specifically, lubricant in the wheel end assembly 1 tends to collect or “pool” below the central axis A_{C} when the assembly 1 is in a static state, i.e., the rotatable component CR is not rotating, such that the location of at least the inlet 17A above the central axis A_{C} minimizes the chance of lubricant even reaching, let alone passing through, through the air vent(s) 16. As such, with only a single air vent 16, the case 12 must be carefully installed to ensure that the inlet 17A is not located below the central axis A_{C} by a sufficient radial distance such that the inlet 17A is immersed within the lubricant pool, thereby preventing air flow into the vent 16.

However, it must be noted that even if the inlet 17A is located within lubricant, the lubricant is incapable of passing entirely through the channel 18 (when extending at least 180°) as gravity will prevent any lubricant from flowing above the remainder of the pooled lubricant, and clearly cannot pass vertically above the inner member 2. Thus, no lubricant will reach the second chamber C₂ through the air vent 16, although a vent 16 having an inlet 17A disposed within pooled lubricant cannot function as intended to vent air pressure.

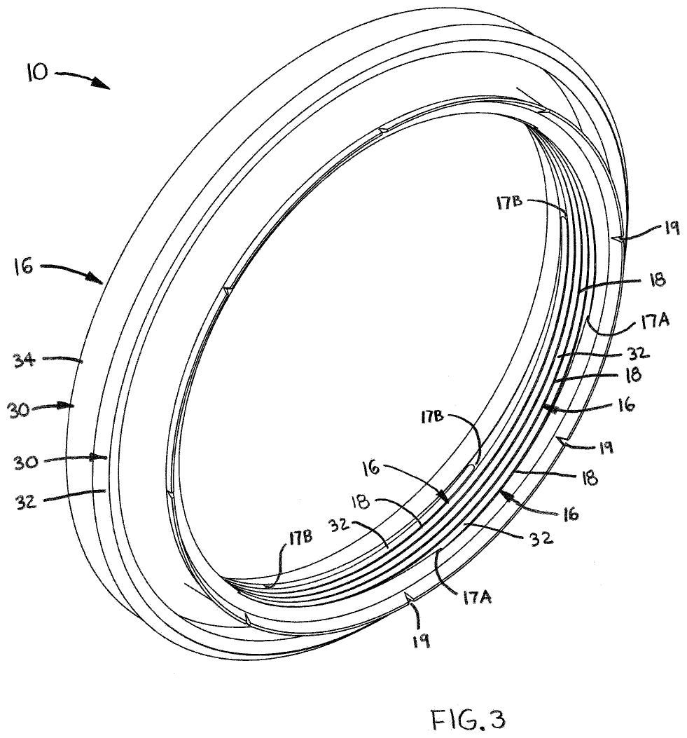

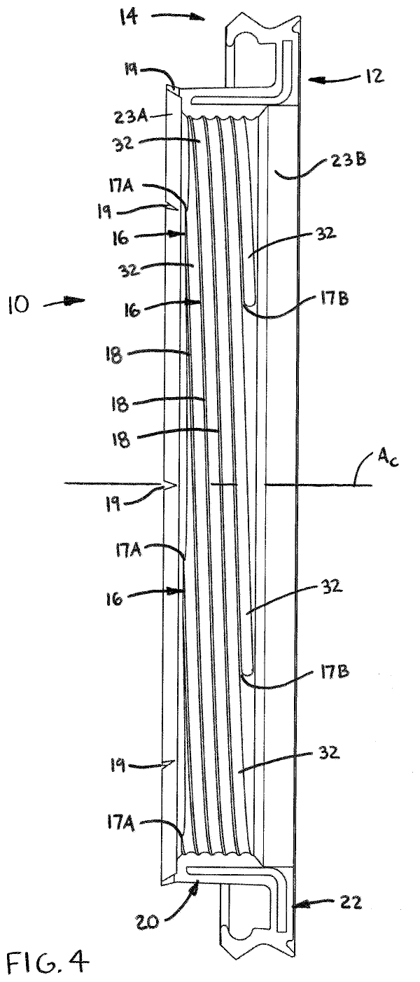

Therefore, to facilitate installation of the seal 10 (i.e., by not requiring a specific case orientation), the at least one air vent 16 preferably includes a plurality of air vents 16 spaced circumferentially apart about the central axis A_{C}. As such, the inlets 17A of the vents 16 are spaced about the entire perimeter of the case cylindrical portion 20 and the plurality of channels 18 are “nested” together and are axially overlapping, as shown in FIGS. 3-5. In a presently preferred construction, the plurality of air vents 16 includes six air vents 16, each of the inlets 17A of the six channels 18 being spaced circumferentially apart from each one of two adjacent inlets 17A by about sixty degrees (60°) and each of the channel outlets 17B being spaced circumferentially apart from each one of two adjacent outlets 17B by about sixty degrees (60°), as best shown in FIG. 4. However, the plurality of air vents 16 may include only two air vents 16 or more than six vents 16 and/or the plurality of vents 16 may be “unevenly” spaced apart; e.g., the seal 10 may include six vents 16 with at least some of the inlets 17A and some of the outlets 17B being spaced apart from each other by more than, or less than, sixty degrees. Further, in the preferred construction including annular inlet and outlet channels 23A, 23B as described above, all of the inlets 17A are fluidly connected with the inlet channel 23A and all of the outlets 17B are fluidly connected with the outlet channel 23B.

Preferably, the elastomeric section 28 of the case cylindrical portion 20 includes a plurality of radial beads 32 extending axially and circumferentially about the central axis A_{C}. With such beads 32, the channel 18 of each one of the plurality of the air vents 16 is defined between each pair of adjacent radial beads 32, which are preferably formed in an appropriate molding process. However, the channels 18 may alternatively be formed by cutting or molding grooves radially into the elastomeric section 28 or may even be provided by cutting, coining or otherwise forming in a surface of the case metallic section 26 if the case cylindrical portion 20 is fabricated without an elastomeric section.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A vehicle wheel end assembly comprising:
an inner member having a central horizontal axis;
an outer member disposed circumferentially about the inner member so as to define an annular space between the inner member and the outer member, one of the inner member and the outer member being a rotatable component configured to rotate about the central axis and the other one of the inner member and the outer member being a static component; and
a seal for sealing the annular space and including:
an annular case having a cylindrical portion with a circumferential surface engaged with the static component and a flange portion extending radially from the cylindrical portion;
an annular seal member attached to the flange portion of the case and having at least one sealing lip engaged with the rotatable component so as to separate the annular space into a first chamber and a second chamber; and
at least one air vent including a channel extending circumferentially and axially around at least a section of the circumferential surface of the cylindrical portion of the case, the channel having an inlet fluidly connected with the first chamber and an outlet spaced axially from the inlet and fluidly connected with the second chamber.

2. The wheel end assembly as recited in claim 1, wherein the seal is configured to prevent lubricant flow between the first and second chambers and the at least one air vent is configured to fluidly connect the first and second chambers so as to reduce air pressure within the first chamber.

3. The wheel end assembly as recited in claim 1, wherein the channel of the at least one air vent extends circumferentially at least one hundred eighty degrees around the central axis.

4. The wheel end assembly as recited in claim 1, wherein the channel of the at least one air vent is formed as a helix.

5. The wheel end assembly as recited in claim 1, wherein the at least one air vent includes a plurality of air vents spaced circumferentially apart about the central axis.

6. The wheel end assembly as recited in claim 5, wherein the plurality of air vents includes six air vents, each of the inlets of the six channels being spaced circumferentially apart from each one of two adjacent inlets by about sixty degrees and each of the outlets of the six channels being spaced circumferentially apart from each one of two adjacent outlets by about sixty degrees.

7. The wheel end assembly as recited in claim 1, wherein the at least one air vent includes an inlet port extending radially through the cylindrical portion of the case and fluidly connected with the inlet of the channel.

8. The wheel end assembly as recited in claim 1, wherein the cylindrical portion of the case includes an annular metallic section and an annular elastomeric section disposed about or within the metallic section, the channel of the at least one air vent being formed in the elastomeric section.

9. The wheel end assembly as recited in claim 8, wherein the elastomeric section of the cylindrical portion has a first circumferential surface attached to the metallic section of the case and an opposing second circumferential surface frictionally engaged with the static component, the channel of the at least one air vent extending radially into the elastomeric section.

10. The wheel end assembly as recited in claim 8, wherein the elastomeric section of the cylindrical portion includes a plurality of radial beads extending axially and circumferentially about the central axis and the channel of each one of a plurality of the air vents is defined between each pair of adjacent radial beads.

11. The wheel end assembly as recited in claim 1, wherein the flange portion of the case extends vertically with respect to the horizontal central axis and the channel of the at least one air vent is located on the cylindrical portion of the case such that the inlet of the channel is located vertically above the central axis.

12. The wheel end assembly as recited in claim 1, wherein the at least one sealing lip of the seal member is a radial sealing lip engaged with a circumferential surface of the rotatable component or a circumferential surface of a component disposed about or within the rotatable component.

13. A wheel end assembly comprising:
an inner, static member having a central horizontal axis;
an outer member disposed circumferentially about the inner member so as to define an annular space between the inner member and the outer member, the outer member being rotatable about the central axis; and
a seal for sealing the annular space and including:
an annular case having a cylindrical portion with an outer circumferential surface engaged with an inner circumferential surface of the inner member and a flange portion extending radially outwardly from the cylindrical portion;
an annular seal member attached to the flange portion of the case and having at least one sealing lip engaged with the outer member so as to separate the annular space into a first chamber and a second chamber; and
at least one air vent including a channel extending circumferentially and axially around at least a section of the outer surface of the cylindrical portion of the case, the channel having an inlet fluidly connected with the first chamber and an outlet spaced axially from the inlet and fluidly connected with the second chamber.

14. The wheel end assembly as recited in claim 13, wherein the seal is configured to prevent lubricant flow between the first and second chambers and the at least one air vent is configured to fluidly connect the first and second chambers so as to reduce air pressure within the first chamber.

15. The wheel end assembly as recited in claim 13, wherein the flange portion of the case extends vertically with respect to the horizontal central axis and the channel of the at least one air vent extends circumferentially at least one hundred eighty degrees around the central axis, the channel being located on the cylindrical portion of the case such that the inlet of the channel is located vertically above the central axis.

16. The wheel end assembly as recited in claim 13, wherein the channel of the at least one air vent is formed as a helix.

17. The wheel end assembly as recited in claim 13, wherein the at least one air vent includes a plurality of air vents spaced circumferentially apart about the central axis.

18. The wheel end assembly as recited in claim 17, wherein the plurality of air vents includes six air vents, each of the inlets of the six channels being spaced circumferentially apart from each one of two adjacent inlets by about sixty degrees and each of the outlets of the six channels being spaced circumferentially apart from each one of two adjacent outlets by about sixty degrees.

19. The wheel end assembly as recited in claim 13, wherein the cylindrical portion of the case includes an annular metallic section and an annular elastomeric section disposed about and/or within the metallic section, the channel of the at least one air vent being formed in the elastomeric section.

20. The wheel end assembly as recited in claim 19, wherein the elastomeric section of the cylindrical portion includes a plurality of radial beads extending axially and circumferentially about the central axis and the channel of each one of a plurality of the air vents is defined between each pair of adjacent radial beads.
